(19) United States
(12) Patent Application Publication
(10) Pub. No.: US 2014/0174567 A1
(43) Pub. Date: Jun. 26, 2014

(54) LIQUEFIED PETROLEUM GAS (LPG) BOMBE VALVE APPARATUS

(71) Applicants: HYUNDAI MOTOR COMPANY, Seoul (KR); KIA MOTORS CORPORATION, Seoul (KR)

(72) Inventors: Ju Tae Song, Hwaseong (KR); Bu Yeol Ryu, Hwaseong (KR)

(73) Assignees: KIA MOTORS CORPORATION, Seoul (KR); HYUNDAI MOTOR COMPANY, Seoul (KR)

(21) Appl. No.: 13/846,545

(22) Filed: Mar. 18, 2013

(30) Foreign Application Priority Data
Dec. 26, 2012 (KR) 10-2012-0153736

(51) Int. Cl. B60K 15/03

(52) U.S. Cl. CPC B60K 15/03
USPC 137/522

(57) ABSTRACT

An LPG bombe valve apparatus includes a valve body, a check valve, a cam, a cam rod and a converting mechanism. More specifically, the valve body is disposed in an LPG bombe and having a fuel channel therein for discharging fuel supplied from an LPG line to the LPG bombe. The check valve is disposed in the fuel channel, with one end supported by an elastic member to be pressed to close the fuel channel. The cam is disposed within the check valve, and the cam rod connects the cam with the check valve and controls opening/closing of the check valve in accordance with rotation of the cam. A converting mechanism has both ends connected to the cam and a float of the LPG bombe converting vertical motion of the float into rotational motion of the cam.

### CROSS-REFERENCE TO RELATED APPLICATION

This application claims under 35 U.S.C. §119(a) the benefit of Korean Patent Application No. 10-2012-0153736, filed Dec. 26, 2012, the entire contents of which are incorporated herein by reference.

### BACKGROUND

(a) Technical Field

The present invention relates to a fuel tank for a vehicle using Liquefied Petroleum Gas (LPG) fuel, and more particularly, an LPG bombe valve apparatus that consistently maintains a pressure of an LPG bombe constant.

(b) Background Art

In the LPG vehicle using LPG (Liquefied Petroleum Gas) as fuel in the related art, LPG is vaporized and supplied to the engine. However, sometimes LPI (Liquefied Petroleum Injection) that directly injects LPG fuel in a liquid state under high pressure by means of an injector is used to improve starting during winter. In this case, a fuel pump may loose the ability of suction due to cavitation, when there is an abrupt change in composition of the fuel or temperature or pressure inside the LPG bombe while LPG fuel is being refilled.

As such, a fuel tank has been proposed in which fuel is supplied through both of a liquid-state discharge port formed at the end of a filling pipe and a gas-state discharge port formed at an upper portion of the filling pipe such that the pressure at a gas-state side in an LPG bombe is kept constant, thereby preventing a filling delay due to an increase in pressure at the gas-state side.

FIG. 1 is a view showing an LPG bombe valve apparatus of the related art and FIG. 2 is a view showing in detail the part A in FIG. 1, in which as a float 70 moves up with fuel full, back pressure is generated in a movable valve V and the movable valve V moves forward, thereby cutting off the filled fuel.

However, back pressure is not generated in the movable valve V, when the fuel is discharged in a liquid-state side at the lower portion of the LPG bombe, so back pressure will not be generated when the filling fuel forms a filling channel to the liquid-state side. Therefore, the filling is not cut off appropriately and the ratio of liquid state and gas state is not appropriately distributed. Accordingly, the temperature or pressure of the LPG bombe increases too and the pressure of the LPG bombe excessively increases as well during filling, so it is difficult to refill the fuel under severe conditions during the hot season.

Therefore, it is necessary to develop an LPG bombe valve apparatus that appropriately distributes filling fuel to a liquid state and a gas state so that the pressure of the LPG bombe may not be excessively increased even under diverse environmental conditions.

The description provided above as a related art of the present invention is just for helping understanding the background of the present invention and should not be construed as being included in the related art known by those skilled in the art.

### SUMMARY OF THE DISCLOSURE

The present invention has been made in an effort to solve the above problems and an object of the present invention is to provide an LPG bombe valve apparatus that appropriately distributes filling fuel to a liquid state and a gas state so that the pressure of the LPG bombe may not be excessively increased even under diverse environmental conditions.

In order to achieve the objects of the present invention, an LPG bombe valve apparatus includes: a valve body disposed in an LPG bombe and having a fuel channel therein for discharging fuel supplied from an LPG line to the LPG bombe; a check valve disposed in the fuel channel, with one end supported by an elastic member to be pressed to close the fuel channel; a cam disposed at the other side of the check valve; a cam rod connecting the cam with the check valve and controlling the opening/closing of the check valve in accordance with rotation of the cam; and a converting mechanism wherein both ends are connected to the cam and a float of the LPG bombe converting vertical motion of the float into rotational motion of the cam.

The fuel channel may be extended to the left and right and bent down at 90 degrees. Additionally, a back pressure generating portion making a stratum with different cross-sectional areas may be formed in the fuel channel. Furthermore, a back pressure generating holder formed around the fuel channel may be disposed within the fuel channel and a gas-state hole may be formed in a side of the back pressure generating holder, so fuel may be injected at a predetermined ratio to a gas-state side of the LPG bombe.

Furthermore, a cam may be formed in a disk shape having a predetermined height with a cut portion formed by cutting a portion of a surface including an arc side, and the cam rod may open/close the check valve by a sliding motion while forming a predetermined displacement when the cam rotates. The portion coming in contact with the cam rod of the cut portion may be made flat.

Finally, the converting mechanism may be implemented by a rack and pinion gear connecting the cam with the float, thereby as the float vertically moves, the cam may rotate.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view showing an LPG bombe valve apparatus of the related art;

FIG. 2 is a view showing the part A of FIG. 1 in detail;

FIG. 3 is a view showing an LPG bombe valve apparatus according to an exemplary embodiment of the present invention;

FIG. 4 is a cross-sectional view taken along the line B-B of FIG. 3; and

FIG. 5 is a view showing an inside of the LPG bombe.

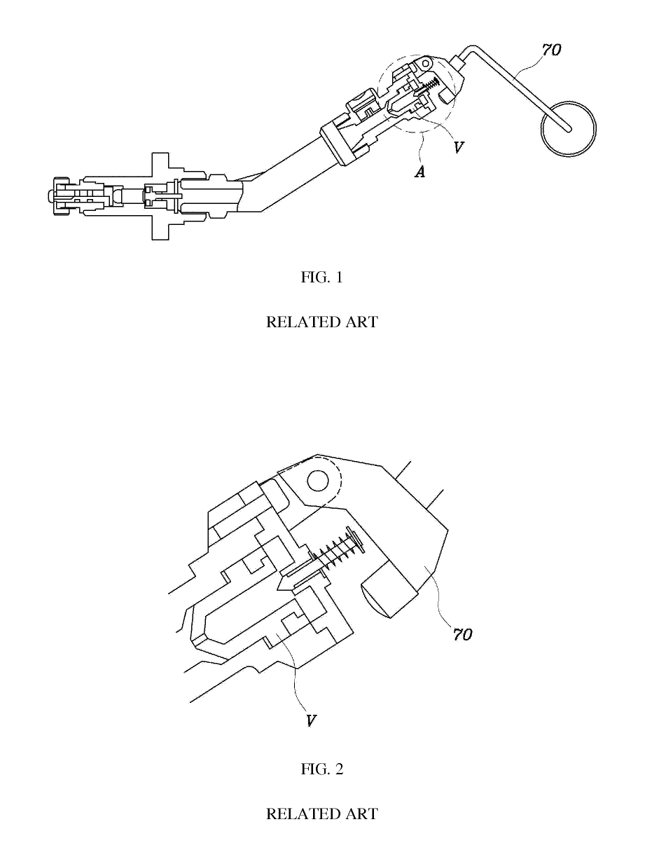

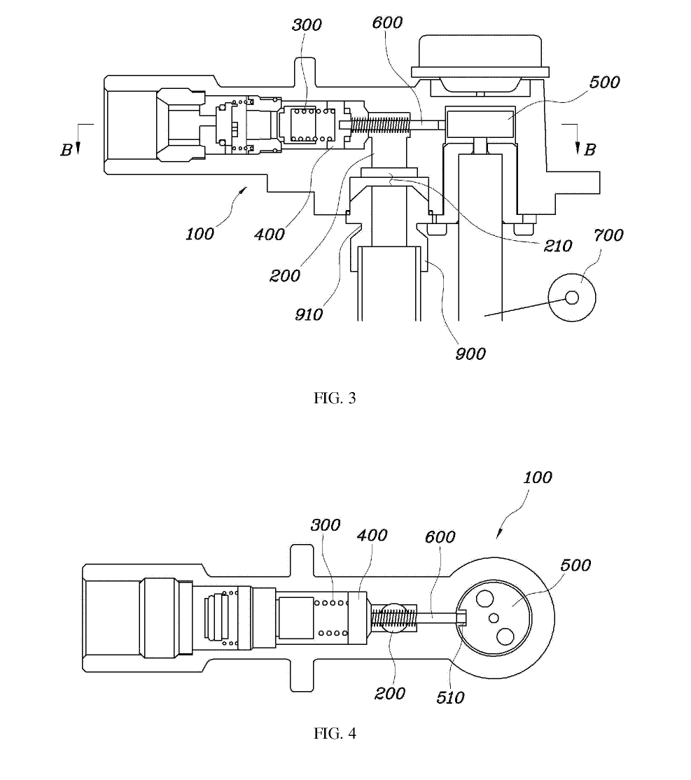

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

An LPG bombe valve apparatus according to exemplary embodiments of the present invention is described hereafter with reference to the accompanying drawings.

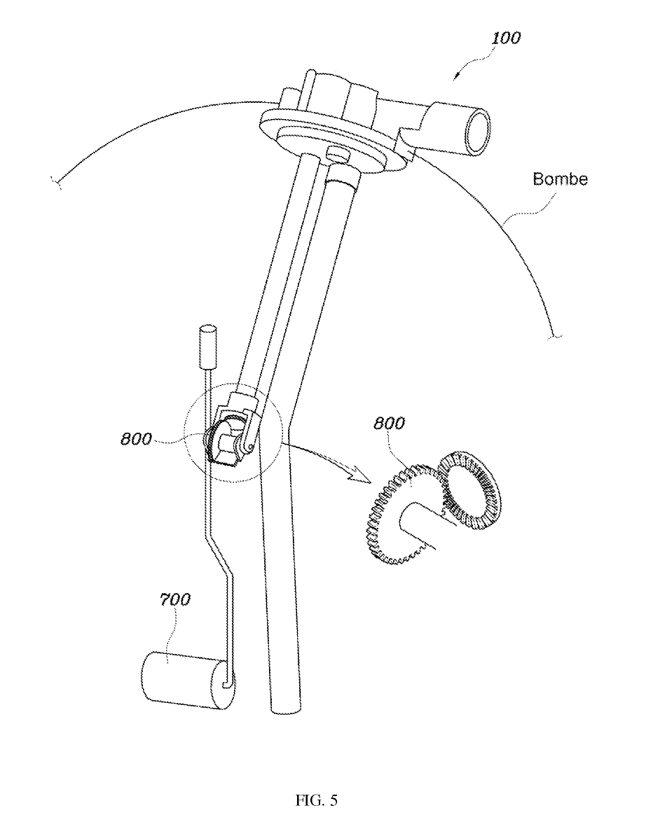

FIG. 3 is a view showing an LPG bombe valve apparatus according to an exemplary embodiment of the present invention, FIG. 4 is a cross-sectional view taken along the line B-B of FIG. 3, and FIG. 5 is a view showing the inside of the LPG bombe. The LPG bombe valve apparatus includes a valve body 100 disposed in an LPG bombe and having a fuel channel 200 therein for discharging fuel supplied from an LPG line to the LPG bombe. A check valve 400 is disposed in the fuel channel 200, with one end supported by an elastic member to be pressed to close the fuel channel 200. A cam 500 is disposed at the other side of the check valve 400. A cam rod 600 connects the cam 500 with the check valve 400 and controls the opening/closing of the check valve 400 in accordance with rotation of the cam 500. A converting mechanism 800 is also provided wherein both ends are connected to the cam 500 and a float 700 of the LPG bombe converting vertical motion of the float 700 into rotational motion of the cam 500.

As shown in FIG. 4, the cam 500 has a disk shape having a predetermined height with a cut portion 510 formed by cutting off a portion of the surface having an arc side, so when the cam 500 rotates, the cam rod 600 forms a predetermined displacement and slides to the left and right of the fuel channel 200, thereby opening/closing the check valve 400. Further, the portion coming in contact with the cam rod 600 of the cut portion 510 is formed flat so that the cam rod 600 may stably come in contact with the cut portion 510 of the cam 500.

In general, liquid fuel is injected into an LPG bombe. However, when the liquid fuel is fully transferred to a liquid-state side at the lower portion of the LPG bombe, the pressure of the LPG bombe increases excessively, so the internal pressure of the LPG bombe increases higher than the pressure for filling the fuel under severe conditions in the hot season, and thus fuel filling is not available. Such a problem occurs because back pressure is not generated sufficiently when a back pressure type valve is used for appropriately distributing and filling the fuel to a liquid-state side and a gas-state side in the LPG bombe, so it is difficult to cut off the fuel. Accordingly, the illustrative embodiment of the present inventions rotates the cam 500 to ensure a sufficient amount of back pressure is generated.

Further, in order to appropriately distribute fuel to the liquid-state side and the gas-state side during filling of fuel, it is necessary to keep a constant ratio of the fuel discharged to the liquid-state side and the fuel discharged to the gas-state side, but the ratio may change in accordance with the kinds of vehicles or the environment in which vehicles travel, so it depends on the designers. However, in the LPG bombe valve apparatus according to the exemplary embodiment of the present invention, fuel is distributed with the optimum ratio, 5% to the gas-state side and 95% to the liquid-state side.

The fuel channel 200 extends to the left and right and bends down at 90 degrees in a filling valve body in order to fill the LPG bombe with LPG fuel. A back pressure generating portion 210 is formed in a stratum form with the cross-sectional area decreased and increased at the portion where the fuel channel 200 bent down in order to inject 5% of fuel to the gas-state side, a back pressure generating holder 900 is formed around the fuel channel 200, and a gas-state hole 910 is formed in a side of the back pressure generating holder 900, thereby injecting the fuel to the gas-state side of the LPG bombe. The back pressure generating portion 210 and the back pressure generating holder 900 may be separately or simultaneously disposed and one or more gas-holes 910 may be formed.

FIG. 5 shows in detail the float 700 and the converting mechanism 800. The converting mechanism 800 is implemented by a rack and pinion gear connecting the cam 500 with the float 700, therefore when the float 700 vertically moves, the cam 500 will rotate. Consequently, when the LPG bombe is being filled with fuel, the float 700 is positioned at the lower portion and the cam rod 600 comes in contact with the arc shape portion of the normal side of the cam 500, thereby pressing the elastic member 300 and opening the check valve 400. Accordingly, the fuel is injected through one or more apertures formed at the cam rod 600 of the check valve 400. The injected fuel is ejected by 5% through the back pressure generating holder 900 after passing the back pressure generating portion 210 through the fuel channel 200 and the other 95% flows to the liquid-state side through the fuel channel 200 and is the filled.

The amount of fuel gradually increases during the filling, so the float 700 moves up and the vertical motion of the float 700 rotates the cam 500 through the rack and pinion gear of the converting mechanism 800. When the cam rod 600 is inserted into the cut portion 510 of the cam 500 with full filling of the fuel in the LPG bombe, as the cam 500 rotates, the cam rod 600 slides to the cam 200 by the elastic force of the elastic member 300 and moves the check valve 400 to the cam 200. Since the check valve 400 is formed in a shape that can close the fuel channel by being fitted in the fuel channel, the fuel channel is closed by the check valve and cut off so as not to be filled anymore.

According to the LPG bombe valve apparatus of an exemplary embodiment of the present invention, since the valve opened/closed by a cam is implemented instead of a back pressure valve, it is possible to prevent improper cutting-off of fuel due to poor generation of back pressure in the LPG bombe, improve the performance of distributing fuel to the liquid-state side and the gas-state side such that the fuel is distributed to the liquid-state side and the gas-state side by disposing a back pressure generating portion and a back pressure generating holder in a fuel channel such that the filling fuel is distributed with a predetermined ratio, and overcome the difficulty of refilling fuel due to excessive increase in internal pressure of the LPG bombe during the filling.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An LPG bombe valve apparatus, comprising:
a valve body disposed in an LPG bombe and having a fuel channel therein for discharging fuel supplied from an LPG line to the LPG bombe;
a check valve disposed in the fuel channel, with one end supported by an elastic member which is pressed to close the fuel channel;
a cam disposed within the check valve;
a cam rod connecting the cam with the check valve and controlling the opening/closing of the check valve in accordance with rotation of the cam; and
a converting mechanism wherein both ends are connected to the cam and a float within the LPG bombe converts vertical motion of the float into rotational motion of the cam.

2. The apparatus of claim 1, wherein the fuel channel extends from a first side to a second side of the valve body and bends down at 90 degrees.

3. The apparatus of claim 1, wherein a back pressure generating portion making a stratum with different cross-sectional areas is formed in the fuel channel.

4. The apparatus of claim 1, wherein a back pressure generating holder formed around the fuel channel is disposed at the fuel channel and a gas-state hole is formed at a side of the back pressure generating holder, so fuel is injected with a predetermined ratio to a gas-state side of the LPG bombe.

5. The apparatus of claim 1, wherein a back pressure generating portion making a stratum with different cross-sectional areas is formed at the fuel channel, a back pressure generating holder is formed around the fuel channel, and a gas-state hole is formed at a side of the back pressure generating holder, so fuel is injected with a predetermined ratio to a gas-state side of the LPG bombe.

6. The apparatus of claim 1, wherein the cam is formed in a disk shape having a predetermined height with a cut portion formed by cutting a portion of a surface including an arc side, and the cam rod opens/closes the check valve by a sliding motion while forming a predetermined displacement when the cam rotates.

7. The apparatus of claim 6, wherein the portion coming in contact with the cam rod of the cut portion is flat.

8. The apparatus of claim 1, wherein the converting mechanism is implemented by a rack and pinion gear connecting the cam with the float, so that as the float vertically moves, the cam rotates.
